(19) United States
(12) Patent Application Publication
(10) Pub. No.: US 2016/0343023 A1
(43) Pub. Date: Nov. 24, 2016

(54) Terminal for implementing simultaneous reward programs

(71) Applicant: Steve K. Sorem, Mechanicsburg, PA (US)

(72) Inventor: Steve K. Sorem, Mechanicsburg, PA (US)

(73) Assignee: JPMorgan Chase Bank, N.A., New York, NY (US)

(21) Appl. No.: 11/221,706

(22) Filed: Sep. 9, 2005

Related U.S. Application Data
(60) Provisional application No. 60/687,860, filed on Jun. 7, 2005.

(51) Int. Cl. G06Q 30/02; H04W 8/00; H04W 8/20; H04W 4/04

(52) U.S. Cl. CPC G06Q 30/0231; G06Q 30/0238; H04W 4/04; H04W 8/005; H04W 8/205

(57) ABSTRACT

According to various embodiments, a system and method for implementing one or more customer reward programs are provided. The presence of a customer inside a store of a merchant is detected by a reward terminal. First reward earning information is automatically generated at the reward terminal based on at least one reward program and the customer's presence inside the store. The reward terminal may located inside the store and may be physically distinct from any point-of-sale terminal used for selling goods that are located inside the store.

### RELATED APPLICATIONS

This application claims priority to U.S. Provisional Patent Application Ser. No. 60/687,860 filed Jun. 7, 2005, the disclosure of which is incorporated herein by reference in its entirety.

### FIELD OF THE INVENTION

The present invention relates to reward programs that enable customers to earn rewards. More particularly, the present invention relates to a physical terminal inside a merchant store that may implement rewards programs for customers inside the merchant store.

### BACKGROUND

Merchants use rewards programs and other incentives to attract and retain customers. For instance, merchants may provide rebates or discounts on specific items purchased at the store. For instance, merchants may apply the discount at the point of sale (POS) and charge the customer a discounted amount for the purchased item. For rebates, customers may earn the rebate by purchasing a designated item, and the rebate may be redeemed at the POS of the designated item. Alternately, the amount of the rebate may be distributed to the customer sometime after purchase. Merchants also distribute coupons via newspaper, email, and other distribution channels, such as distribution at the POS. Some incentives enable customers to earn free items after making a specified number of purchases, e.g., over a specific length of time. For instance, Quizno's™ may offer a free sandwich if a customer purchases four different sandwiches during the month of August. After satisfying the terms and conditions of any incentive offer, customers may use these and other coupons towards the purchase of items, e.g., items at the merchant store. The coupon may be redeemed at the point of sale (POS).

Coupons and other benefits provide incentives for the customer to purchase future items from the merchant. For example, customers may return to the merchant in order to redeem a previously-earned rebate or award, or to earn a subsequent rebate or award. Other things being equal, the more visits and purchases from a specific merchant and/or merchant store, the more “sticky” or loyal that customer will be to the merchant. This is partly because repeated contact engenders greater familiarity and knowledge of the merchant's product and store, which facilitates the shopping experience. Further, people will often return to a store merely out of habit.

Although conventional systems and methods enable merchants to provide customer incentives to create “stickiness,” these incentive programs are typically untargeted offers available to the public. The rewards are typically earned and redeemed outside the scope of any reward account of the customer. Rather, a typical rebate check is simply mailed to the customer, and the customer must then deposit in the customer's bank like any other fund transfer from a third party. After a customer claims a rebate offered equally to all consumers, there is little to prevent the customer from visiting a competitor's store for the next purchase if the competitor offers a slightly lower price. Further, there is often little information gathered about the specific customer during the course of a typical reward-redemption cycle.

In some prior art systems, customers may be dynamically notified in real time at a point of sale or customer device (such as a cell phone) about various offers and promotions, which may be specifically targeted to the customer. Some of these features of the prior art are disclosed in commonly-assigned U.S. application Ser. No. 09/843,943, filed Apr. 30, 2001, the disclosure of which is incorporated herein by reference in its entirety.

What is needed is a reward system and method that better motivates customers to purchase from a particular merchant or merchant store.

### SUMMARY OF THE INVENTION

According to various embodiments, a method for implementing one or more customer reward programs is provided. The presence of a customer inside a store of a merchant is detected by a reward terminal. First reward earning information is automatically generated at the terminal based a one reward program and/or the customer's presence inside the store.

According to another exemplary embodiment, a terminal for implementing one or more rewards programs is provided. An environment monitoring device obtains identification information of one or more customers inside a store of a merchant. A customer identification module identifies a customer based on the received customer identification information, the customer being enrolled in at least one reward program. A reward processor determines reward earning information based on the received customer identification information and the at least one reward program.

According to another exemplary embodiment, a method for implementing one or more customer reward programs is provided. Customer identification information is received from a customer reward account key fob of a customer at a reward terminal inside a merchant store, wherein the reward terminal is physically separate from one or more point-of-sale devices used to initiate purchase transactions. The customer is identified based on the customer identification information. Reward earning information is automatically generated based on at least one reward program and the customer's presence inside the store. Information based on the generated reward earning information is output at the reward terminal reward.

According to another exemplary embodiment, a method for implementing one or more customer reward programs is provided. The presence of a customer inside a store of a merchant is detected by a reward terminal. The reward terminal is physically distinct from any point-of-sale terminal used for selling goods located inside the store. First reward earning information is automatically generated at the reward terminal based on at least one reward program and the customer's presence inside the store.

Other embodiments may also be considered.

### BRIEF DESCRIPTION OF THE DRAWINGS

FIG. 1 shows an exemplary system for implementing a rewards program using a terminal.

FIG. 2 depicts a flow chart illustrating an exemplary method for implementing a reward program using a terminal.

### DETAILED DESCRIPTION OF EXEMPLARY EMBODIMENTS

In various embodiments, a terminal in a merchant store may be used to implement a plurality of rewards programs for a plurality of customers. Some or all of the customers may participate in some or all of the rewards programs. Rewards may be earned by customers based on various reward-earning behaviors, such as making purchases of merchant items, and also by visiting the store. The terminal may track customer attendance to the store, signal the earning of a reward, monitor customer behaviors, dispense rewards and reward vouchers, and communicate customer reward and account data.

In some embodiments, one or more rewards programs may be implemented to encourage customers to visit (and/or frequent) a physical merchant store. For instance, reward-earning behaviors of one rewards program may comprise visiting the store. A store visit may be recorded by swiping a customer rewards card (or otherwise inputting customer identification information) at a terminal, such as a point-of-sale terminal. It should be understood that a visit may also be tracked when a customer purchases an item at the merchant store using a credit card, since the user's identity may be determined from the user's credit card.

In some embodiments, customers may select, exchange, and redeem rewards of one or more different rewards programs at a terminal, as well as accomplish any other function related to one or more rewards programs or rewards.

The rewards program may be associated with (and managed by) a particular entity such as a company, bank, card issuer, retail store, or other business-related entity.

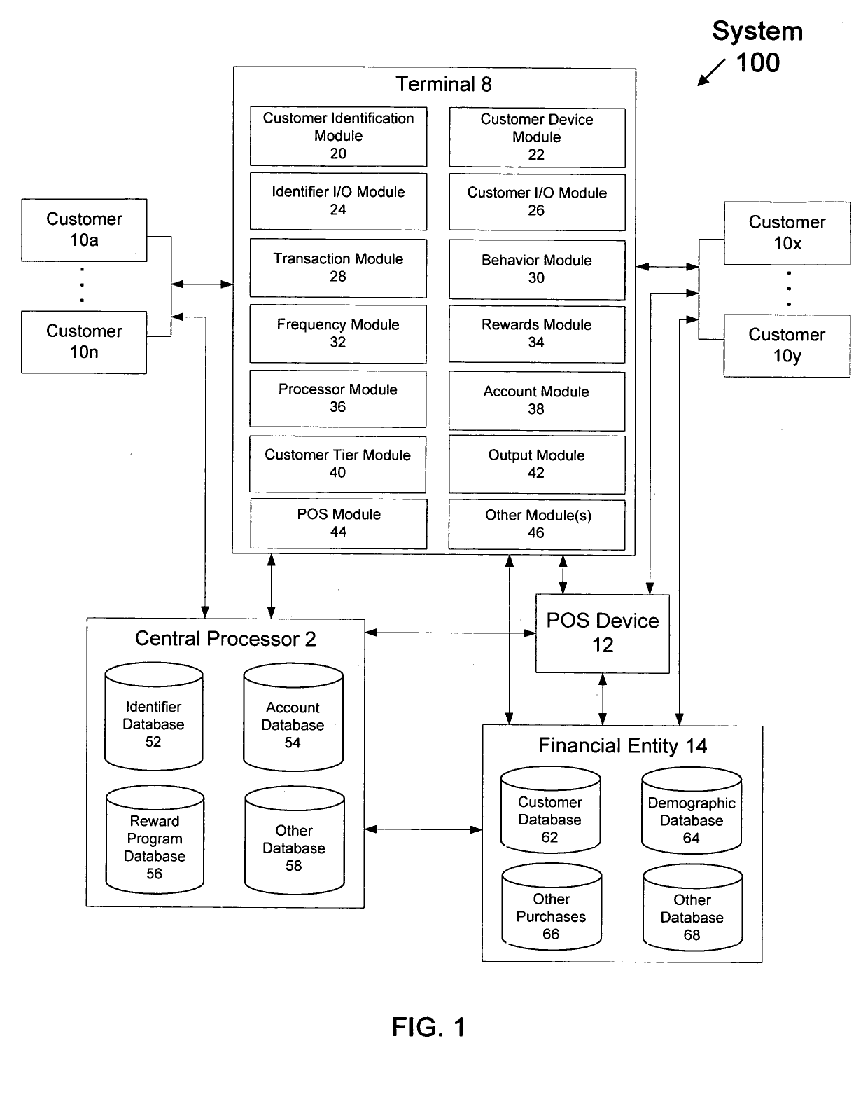

FIG. 1 shows an exemplary system 100 for implementing a reward program for one or more customers 10 using one or more terminals 8 linked to a central processor 2. The customers 10, terminal 8, and central processor 2 may also communicate with POS device 12 and/or financial entity 14.

In some embodiments, a central processor 2a associated with one merchant, such as an airline reward provider, may communicate with one or more terminals 8 associated with another (or the same) merchant, such as an electronics retailer. For instance, a central processor associated with an electronics manufacturer may communicate with terminals inside a plurality of stores of a particular retailer who sells the manufacturer's products. The central processor of the manufacturer may implement a plurality of rewards programs for customers of the retail store via the terminals 8 inside the store.

In some embodiments, there may be other central processors 2b-2n that implement similar (or different) rewards programs for other merchants via terminals inside the merchants' stores (or elsewhere). A financial entity 14 may receive information, such as customer purchase and reward information, from the plurality of central processors 2a-2n. The financial entity 14 may monitor and/or implement various rewards programs with one or more of the central processors 2a-2n and merchants for one or more customers of the merchants. For instance, a credit card issuer may monitor customer purchasing behavior at all participating merchant stores (e.g., and/or customer purchases from non-participating stores) and implement one or more rewards programs described herein via the terminals 8. The financial entity 14 may also use the customer information (and information about the merchants, terminals 14, and entities associated with each central processor 2a-2n) for other purposes, such as targeting advertisements for financial services such as credit card products.

The central processor 2 may comprise any server, computer system, data processing system, financial account provider system, reward engine, network account provider or manager, hub, centralized processing system, or other entity in a network. In some embodiments, the central processor may be in a location that is remote from at least one terminal 8a and/or the merchant store. Although a single central processor 2 is depicted, it should be appreciated that multiple central processors 2 may be provided and that such multiple processors 2 may share data and operational tasks to achieve efficiency and operation of the functions described herein. The central processor 2 may also comprise a content provider system. The central processor 2 may comprise input and output devices for communicating with other various system 100 elements.

Central processor 2 may manage customer account and reward program information. Central processor 2 may store customer and reward-related information in any of a plurality of databases, such as identifier database 52, account database 54, reward program database 56, and other database(s) 56.

Identifier database 52 may store any information related to customer and customer account identifiers, such as account numbers, phone numbers (e.g., phone numbers of customers), key fob identifiers (such as a credit card), biometric identification information, and other identification information.

Account database 54 may store any information related to a customer's account or reward account, such as balance and earnings information.

Reward program database 56 may store the conditions and terms that govern the earning of rewards. For instance, reward program database 56 may store random numbers that are used to calculate random winners in a monthly drawing. Reward program database 56 may store information relating to a plurality of different rewards programs that may be implemented during one or more overlapping time periods. Any number of different reward programs may be implemented simultaneously.

Other database(s) may store other information related to customer rewards and accounts.

Terminal 8 may comprise any computer processing system such as central processor 2. Terminal 8 may comprise any computerized kiosk, server, ATM machine (or similar workstation), or other computer system. Terminal 8 may comprise input and/or output devices. The terminal 8 may be a stand-alone kiosk, or it may be integrated into a portion of the merchant store. Terminal 8 may communicate with other terminals in the same merchant store or in a different store (or outside the store or elsewhere).

In some embodiments, terminal 8 may communicate with a point-of sale (POS) device 12. For instance, terminal 8 may be coupled to a POS device 12 over a network. One or more of the terminal 8 and POS device 12 may also be coupled to central processor 2 over the same (or different) network.

POS device 12 may comprise any device used by merchants to facilitate transactions at a point-of-sale (POS). For instance, POS device 12 may comprise a transaction card reader (such as a credit card reader), barcode scanner, cash register, RFID receptor or reader, or other device for receiving or capturing transaction information such as customer information.

In some embodiments, all of the system 100 components may be located inside (or near) a single merchant store. In other embodiments, only one, two, or three, etc., components may be inside the store, such as one terminal 8a and one customer 10a. In some embodiments, the system 100 components may be scattered in locations (such as stores) associated with one or more stores of the merchant (or merchant partner stores or other locations).

Customers 10 may comprise any person who has or may purchase a product or service from a particular merchant. In some embodiments, customers 10 may comprise the group of people who have previously purchased items from the merchant and/or who have accounts with the merchant. For instance, customers 10 may comprise the set of people who have reward accounts with a specific entity such as a merchant or bank (such as a bank associated with the merchant) or other institution. In some embodiments, customers 10 may earn one or more rewards based on transactions and other behaviors inside (and/or associated with) a specific merchant store or set of stores (such as a set of stores of the merchant or another set of stores). In some embodiments, the customer 10 may be an individual or a group of individuals (such as a family or organization).

Any manner of customer identification is contemplated herein.

Terminal 8 may include various modules for providing functionality associated with reward information and earnings, as described as below. Each module may have one or more associated databases, stored locally or remotely, for accomplishing its functions.

Customer identification module 20 may comprise at least one customer identification device. Any sensor device, monitoring device, or computer input device is contemplated herein. For instance, a fingerprint sensor, retinal scanner, biometric scan, DNA scan, or other biometric device may be used to identify a customer 10.

A customer may also be identified by identifying an account associated with the customer. Each customer 10 (or group of customers such as a family unit or extended family and friends unit) may have an associated merchant account and/or a reward account (e.g., a reward account associated with a merchant account). For instance, the reward account may be comprised in the customer's merchant account. The reward account may have a corresponding identifier such as an account number. The identifier may be marked on, stored within, or otherwise associated with a key fob such as a card associated with the account. The key fob may comprise an RFID device, a transaction card, smart card, PDA, personal computer, cell phone (or other telecommunications device), laptop, wireless communication system, data storage system, or any other device that can be used to identify a customer 10 or an account associated with a customer 10. For instance, the customer 10 may have a transaction card having a card number or other identifier that is identical to or associated with the customer 10 or account number (or reward account number).

In some embodiments, customers may input identification information at the terminal 8. For instance, customers 10 may swipe a credit card-shaped key fob at a card-reading device at the terminal 8.

Customer device module 22 may communicate information such as account information with a customer communication device such as a PDA, smart card, laptop, bluetooth-enabled device, RFID, security card, portable gaming console, cell phone, or other communication device, via wired and/or wireless communication. Customer device may accordingly identify a specific customer based on stored customer information and also log a customer in to the system. Identifier I/O module 24 and customer I/O module 26 may perform these and similar functions.

A customer and/or rewards program identification device (such as a key fob) may be provided to registered customers 10, such as an RFID device, ID card, credit card, debit card, stored value card, key fob, or other device. The device may have an associated identification number, such as a card number. The device may have a machine-readable code such as a magnetic stripe or barcode, and in some embodiments the identification number may be encoded in the machine-readable code. Alternately or in addition, reward program identification information may also be programmed into a customer device (such as an RFID or cell phone) that may communicate with the terminal like a key fob, e.g., via wireless communication.

In some embodiments, other information may be input, encoded, or otherwise stored in or on the key fob. Such information may comprise a phone number, name, social security number, address, account number, or other information specific to a customer, family, or other entity associated with a reward account.

Identifier I/O module 24 may communicate information such as account information with a customer 10 and/or customer communication device, e.g., a card, PDA, laptop, or other device. Identifier I/O module 24 may use this information to identify a customer 10.

Identifier I/O module 24 may comprise devices that can receive input from (and/or output to) an indicia of an identifier (such as a smart card or RFID key fob). For instance, identifier I/O module may comprise a magnetic stripe reader, barcode scanner, RFID receiver, smartcard reader, or other card interface device. Identifier I/O module 24 may also receive electronic signature data or other personal identification information, e.g., from a wireless PDA of the customer or other device.

The terminal 8 may also be configured to communicate customer account and reward-related information to a customer 10. For instance, the terminal may be configured to enable a customer to log into an account stored at a central database system. Thus, the terminal may comprise a server or other component of a network configured to communicate with other network elements, such as a central database system. In this way, centralized information may be passed to and from the terminal. For instance, the terminal may communicate with the back-end of a rewards program management system. For instance, a bank issuer on a network may manage the rewards program.

The customer 10 may also be identified by systems and methods that do not involve a key fob (or other customer device). For instance, the customer 10 may enter a login and PIN at the terminal 8. The terminal 8 may receive the login information and accordingly determine that the customer 10 logging in must be physically present at the terminal 8 (and store, as the case may be). In other embodiments, biometric information of the customer 10 may be measured, monitored, and/or otherwise received or identified. The identity of the customer 10 may be determined on this basis.

It should be appreciated that any manner of automatic detection of a key fob is contemplated herein. In one embodiment, the terminal system 100 may identify a customer as soon as the customer enters the store, or shortly thereafter. For instance, the terminal may measure biometric information of the customer and then identify the customer by comparing such data with stored information about the customer.

In some embodiments, customers 10 may register to enroll in one or more of the rewards programs. The customer may also be provided with a key fob or other device, e.g., at a POS or terminal 8. The customer may use this device to gain access to the terminal and/or register at the terminal.

Customer I/O module 26 may communicate reward, account, status, profile, and other reward-related information directly with customer 10. Customer I/O module may comprise a keyboard, microphone, mouse, touch-sensitive display, one or more buttons, one or more switches, and/or any other input device. Customer I/O module 26 may use voice-recognition technology in order to identify a customer by the sound of the customer's voice and also to decipher customer requests. Customer I/O module may also comprise output devices for outputting communications with one or more customers 10, such as a speaker, light (e.g., a strobe light), email server, printer, display, or other output device.

Customer I/O module 26 may enable the customer to access a customer account and other information over the Internet. For instance, the customer may login to a web-based account such as a reward account, merchant account, email account, or financial account. Naturally, the customer may use any services available on the Internet, e.g., managing customer accounts, purchasing items, etc.

In some embodiments, customer I/O module 26 may signal if and when a customer has earned a reward. In some embodiments, a speaker may play a sound to signal the earning of a reward, such as the sound of a person saying, “John Doe, you have just won a free $20 gift certificate usable in this store on your next visit before Nov. 25, 2005. Please go the Reward Kiosk to print out your gift certificate. We thank you for your patronage today, and come again soon to redeem your gift certificate.” This reward signal may be output over a loudspeaker in the store and/or from a speaker at the terminal.

In some embodiments, a light may go off to signal a winner. For instance, bright strobe lights and sirens may go off whenever a customer's visit to a store wins a national grand prize as described below.

Customers 10 may access accounts via the customer I/O module 26. For instance, the terminal 8 may serve as a network connection to a central processor that stores all account-related information. Customers 10 may accordingly inspect and edit reward and account information, pay bills, and also accomplish any other functions that may be accomplished by accessing a merchant account online. For instance, customer 10 may request billing statements and dispute a bill. Customer 10 may also shop for and purchase items available in the store. Customer may then pick up the items, e.g., at a POS device or other location.

In some embodiments, customer may earn a reward such as an online gift certificate. The customer may then access the terminal 8 via the customer I/O module 26 to shop online and purchase an item that may be delivered to the customer or picked up (e.g., immediately) inside the store.

In some embodiments, the terminal 8 may output (e.g., by printing) an identifier related to a reward. For instance, the terminal 8 may print a machine-readable code such as a barcode (or card having a magnetic stripe) that can be used to redeem the reward. For instance, the barcode may be read at a POS device (e.g., via a barcode scanner) during a subsequent transaction to enable a 20% discount on that purchase (or other reward). In some embodiments, the terminal 8 may dispense a gift card having a magnetic stripe. The gift card may have a value such as $5 but may have requirements for use (e.g., printed on the card or displayed at the terminal 8 at the time of dispensing). For instance, the card may only be usable for a purchase of an item that costs $10 or more, it may be inactive until it is activated on the customer's next visit, and it may expire in two weeks.

Transaction module 28 may receive, process, and pass transaction information. Transaction information may comprise any information relating to a customer transaction, such as a customer transaction with the store, the merchant, a merchant affiliate, or another store or merchant. For instance, transaction module 28 may receive transaction information indicating that a customer identified in the store purchased a product sold by the merchant for $30.

Behavior module 30 may receive information relating to customer reward-earning behaviors. For instance, behavior module 30 may communicate with a customer to obtain such reward-earning information. For instance, a customer may earn a reward (or become eligible for a reward) by registering a recently purchased product at the terminal, completing a survey, otherwise transacting business, or otherwise engaging in any behavior associated with reward criteria. In this way, behaviors can be inspected to determine if they are eligible for a reward.

Frequency module 32 may receive and process information related to a customer's visit to a store. For instance, frequency module 32 may determine the frequency with which a particular customer 10 visits the store, a group of stores of the merchant, or another set of stores, locations, or geographies. For instance, a frequency may be determined by dividing the number of relevant customer visits by the corresponding length of time. Frequency module 32 may also track reward information corresponding to frequency. For instance, frequency module 32 may determine whether (and which) rewards have been earned in the past by a given customer.

Finally, frequency module 32 may determine whether and when a customer may earn a reward based on a visit (or number of visits or frequency of visit) to the store (or other behavior).

Data from the modules, such as data from the frequency 32, transaction 28, and behavior 30 modules, may be passed to the rewards module 34 in order to interrogate whether a customer visit (or frequency), customer transaction, and/or customer behavior has earned one or more rewards pursuant to any number of different reward programs.

Reward module 34 may process reward-related information. For instance, reward module 34 may determine whether a customer has earned a reward. The reward module 34 may process reward earning data based on the transaction, behavior modules, and behavior modules 28-32. In effect, reward module 34 may determine whether one or more transactions, behaviors, and store visits warrant a reward. Reward module 34 may also determine reward redemption data, reward alert data, and reward account data. For instance, reward module 34 may determine how many un-redeemed reward points remain in a customer's account.

Processor module 36 may communicate with central processor 2 and/or financial entity 14. As described in further detail below, central processor 2 and/or financial entity 14 may store account and reward-related information for each customer 10. Processor module 36 may request and receive this information from the central processor 2. For instance, central processor 2 may store biometric data of a customer and an account/card number for each customer. When a terminal receives card identification information (such as when a customer 10 swipes a reward card at the terminal 8 or terminal 8 receives biometric information of the customer 10), the terminal 8 may access the central processor 2 and/or financial entity 14 to determine the identity of the customer.

Central processor module 36 may also pass processed information to the central processor, such as any new reward-earning information, reward disbursement information, or other customer- or reward-related information.

Account module 38 enables customers to access their account, as described above with respect to the customer I/O module.

Customer tier module 40 may associate each customer into a category such as a tier. In some embodiments, customers may be placed into different categories or tiers of one or more rewards programs, such as gold, silver, and bronze. A customer in the gold tier may be eligible for a different type of reward (e.g., a more expensive reward) than a customer in the bronze tier, for example. Customers may be assigned to tiers based on any of a variety of criteria. For instance, customers may be assigned into a tier based on an amount of their first purchase in the store. Customers who make a purchase over a specified amount, such as $1000, may be eligible to enroll in the highest (e.g., gold) tier. In some cases a customer's tier may change, such as if a customer who enrolls in a lower tier makes a series of expensive purchases.

For instance, customers may be categorized into “Gold” customers who purchase over $2400 of products from the merchant every year, “Silver” customer who purchase between $500 and $2399 of products from the merchant every year, and “Bronze” customers who purchase less than $500 of products per year.

Customer tier may affect reward earnings and rewards. In some embodiments, different tiers earn different values of rewards. For instance, gold customer are entitled to earn a specific reward that is worth $100, while silver customer may be entitled to earn a similar specific reward that is worth $50. Also, different categories of customers 10 may be entitled to participate in different rewards programs.

However, in some embodiments, one or more categories of customers may participate in some or all of the same reward programs, but the winnings may be proportionately different.

Categories may be permanent or dynamic, e.g., based on various criteria. For instance, a customer may graduate (briefly) to the “Gold” category if the customer's purchases in a single month total over $200 (which is the same purchasing rate as $2400 every 12 months). The customer may drop back down to silver (or bronze) if the spending rate decreases below the $200/month level.

Output module 42 enables the terminal 8 to output physical rewards as well as physical (and electronic) indicia of rewards. For instance, output module 42 may dispense candy bars as a reward to customers who showed up before 10 am on the day of a big sale. In other embodiments, output module 42 may output vouchers and gift certificates as rewards. It should be noted that rewards may be output even if the customer did not earn a reward that day; it is possible for customers to claim an already-accrued reward as described above.

POS module 44 may communicate with one or more POS device 12. For instance, POS module 44 may notify POS device 12 that a specific customer should be credited with a $20 gift certificate during the customer's next purchase. In a similar way, POS device 12 may instruct POS module 44 to credit the customer's rewards account with a $20 gift certificate during the purchase of an item with a $20 merchant-sponsored rebate. The earned $20 gift certificate may be claimed by the customer according to the terms of the $20 promotion. For instance, the customer may request that the terminal 8 print out the gift certificate at the terminal's printer. In other embodiments, the reward may only be claimed at another (linked) terminal, such as a terminal in a store of a merchant partner.

Other module(s) may accomplish other functions related to customers, accounts, and rewards.

In some embodiments, the reward may be claimed at an ATM machine terminal 12 configured according to the present invention to dispense cash rewards based on instructions from a store terminal 12. In some embodiments, terminals 12 may be located in stores and/or in locations such as the lobby of a condo building, in a mall, or in locations similar to the locations of ATM machines.

Reward-earning behaviors can occur at a merchant store, such as a purchase at a store or a non-purchase visit to a store. In some embodiments, reward-earning behaviors may be monitored and tracked at a terminal 8. The terminal 8 may be located inside the store (or elsewhere). In some embodiments, the terminal 8 may be a point-of-sale terminal. In other embodiments, the terminal 8 may be separate from a point-of-sale terminal 12. For instance, the terminal 8 may be a kiosk near the entrance of the store. In some embodiments, the terminal 8 may be a kiosk or other terminal that is configured to communicate with a point-of-sale terminal 12.

The terminal 8 may be able to provide and receive information related to customers 10, customer accounts, rewards, and reward-earning behaviors. For instance, the terminal 8 may comprise one or more input and output devices, such as a card-reader, keypad, and/or touch-sensitive display. In some embodiments, the terminal may be configured to identify when a reward program participant such as a customer 10 visits a store where the terminal 8 is located. For instance, the terminal 8 may receive customer identification information from a customer identification device such as a card having a magnetic stripe, RFID device, or other customer identifier.

In some embodiments, customers may register for one or more rewards programs at the terminal. For instance, after a purchase inside the store, a customer may be provided with a registration code. A central database system may record the registration code as well as information about the customer's purchase, such as information about a customer's credit card used to make the purchase. The customer may enter the registration code at the terminal and then provide registration information, such as the customer's name and address.

It should be appreciated that the various functions of the terminal 8 may be accomplished by the central processor 2. For instance, the central processor 2 may have all the modules and databases described above for the terminal 8. In some embodiments terminal 8 may serve primarily as an information-gathering and I/O module for the central processor 2, which accomplishes various functions described above for the terminal 8 such as determining rewards and managing reward accounts and programs. In some embodiments it is preferable to manage the reward accounts of a plurality of customers and/or stores at a central processor 2 coupled to a centralized database.

Financial entity 14 may comprise any financial entity such as a banking institution, credit card company or issuer, rewards program manager, or other financial service provider, and it may comprise any database management system of such entity. For instance, financial entity 14 may comprise a central processor (such as an entity similar to central processor 2).

Financial entity 14 may comprise one or more databases 62-68 and modules (such as those described above for terminal 8).

Customer database 62 may determine and store customer information, such as information about customer accounts, customer profiles, customer rewards programs, and any other customer-related information described herein. For instance, customer database 62 may receive, process, and store information based on a customer's purchases from a plurality of different merchants (e.g., merchants having stores with terminals 8). For instance, customer database 62 may store information about the buying patterns of a particular customer.

Demographic database 64 may determine and store information about one or more customers or groups of customers, such as demographic information (e.g., age, gender, height, weight, address, income, credit rating information, purchasing behavior, etc.).

Other purchases database 66 may determine and store information about other purchases made by one or more customers. Other purchases may include purchases unrelated to any terminal 14 or merchant associated with a terminal. For instance, other purchases may include purchases made by a customer online from a non-participating retailer using a credit card (or other transaction card or key fob) issued by (or monitored by) the financial entity 14.

Other database 68 may process and store other information.

In some embodiments, financial entity 14 may process and store detailed information about a plurality of customers 10. The financial entity 14 may use the terminals 14 and POS devices to identify customers 10, e.g., based on a key fob such as a credit card issued by the financial entity. Based on one or more rewards programs implemented by one or more central processors 2 (and/or financial entity 14), financial entity 14 may provide targeted ads and rewards to customers. For instance, if a specific customer has been determined to make a large number of purchases related to music (e.g., by purchasing music CDs and speakers at POS devices of a particular participating electronics retailer), then financial entity 14 may cause ads and rewards to be provided to the customer. The targeted ads and rewards may be provided to the customer via terminals 8, such as terminals 8 at the electronics retailer and/or terminals 8 of a different retailer. The targeted ads and rewards may also be provided via other means of communication, such as when the customer logs into a customer account associated with the financial entity (such as a credit card account), e.g., via billing statements, direct mailings, email, and other communications. The financial entity 14 may accordingly implement various rewards programs which may be independent from, and/or complementary to, the rewards programs of any merchant or central processor 2.

The reward programs implemented via the systems and methods described herein may comprise any rewards program and may be implemented by any system or method, such as those described in the U.S. application entitle “Rewards Program System and Method” and filed Aug. 11, 2005 under Attorney Docket Number 47004.000329.

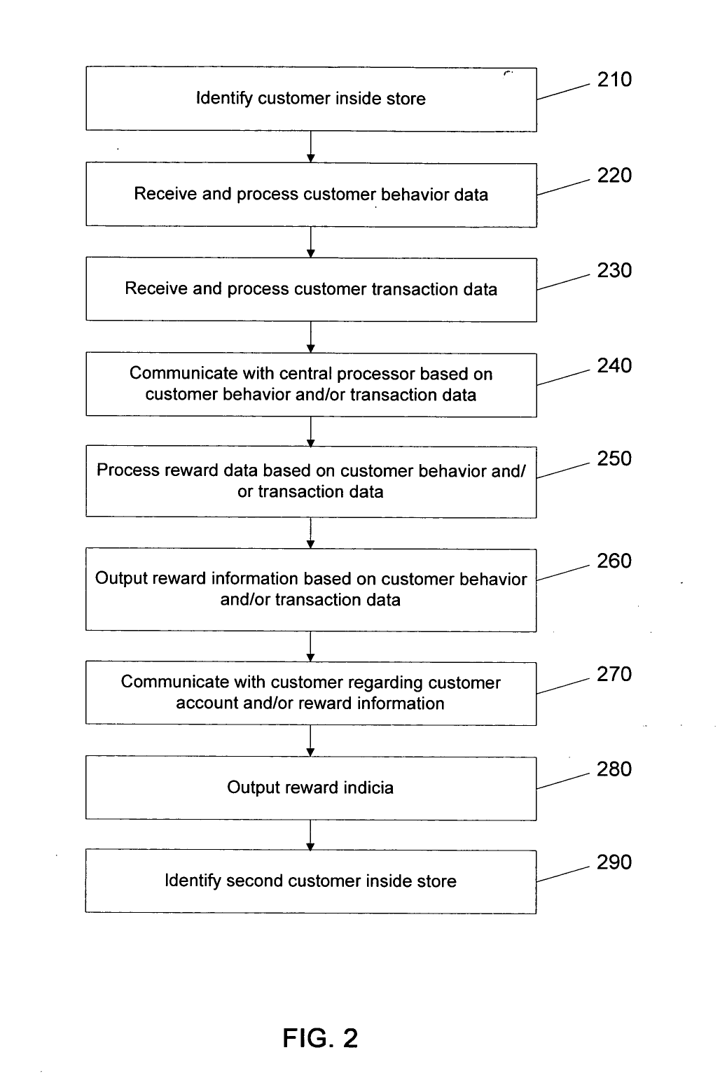

FIG. 2 shows a flow chart illustrating an exemplary method for implementing a reward program using a terminal.

In block 210, a customer inside the store may be identified, e.g., automatically by the terminal. For instance, an input device may receive card identification data and/or biometric data of a customer. The terminal may identify the customer based on this information.

In block 220, customer behavior data may be received and processed, e.g., automatically at the terminal. For instance, the terminal may monitor a survey that is completed by the customer at the terminal Completing the survey may earn a reward pursuant to an active reward program.

In block 230, customer transaction data may be received and processed. For instance, the customer may conduct a purchase transaction for a $300 item at a POS device in the store. The POS device may pass this transaction information to the terminal.

In block 240, an entity such as the terminal may communicate with a central processor based on the customer behavior and/or transaction data. For instance, the terminal may notify the central processor that the customer just purchased a $300 item.

In block 250, reward data may be processed based on customer behavior and/or transaction data. The terminal (or central processor) may determine that (1) the purchase earned a $30 rebate which may be credited to the customer's account, (2) taking the survey earned a 10% off coupon usable on the customer's next visit, and (3) the customer's visit to the store makes the customer eligible to participate in a national grand prize drawing.

In block 260, reward information may be output based on customer behavior and/or transaction data. For instance, the information may be output at a terminal or POS device. For instance, the customer may request the $30 rebate in cash from the terminal, and the customer may return to the POS device on the next visit to apply the 10% coupon to the customer's next purchase (or any subsequent purchase).

In block 270, an entity such as the terminal may communicate with the customer regarding the customer's account and/or reward information. For instance, the customer may log into the customer's account via the terminal and request account balance information. The customer may further request the $30 rebate.

In block 280, reward indicia may be output, e.g., at the terminal. The reward indicia may be a reward, or it may be an indicia of a reward (such as a coupon redeemable at a POS). For instance, terminal may output $30 in cash at the terminal in response to the customer's request for the rebate.

In block 290, a second customer may be identified, e.g., automatically by the terminal. For instance, a second customer may be identified automatically by the terminal. In some embodiments, the second customer may be different from the first customer. The second customer may earn rewards, make purchases, check account balance information, etc., in the same ways as described for the first customer. The second customer may have one or more of the same applicable reward programs.

In other embodiments, the second customer may be the same as the first customer. For instance, the (first) customer may visit the store at a later date, and the terminal may once again determine when the customer enters the store (or purchases an item, etc.). Additional rewards may be earned pursuant to one or more rewards programs. For instance, this time the customer may win the national grand prize. Further, the customer may now be entitled to apply the 10% off coupon toward the customer's next purchase, pursuant to the customer's prior reward earnings. Reward accrual based on frequency, transactions, and behavior may be similarly processed as described above.

At this point, one or more actions described in blocks 210-280 may be repeated.

In some embodiments, the rewards program(s) may comprise any or all of the following reward program features described in the following examples.

### Example 1

Instant Win. A customer may participate in this program once per day (or another specified number of times in a specified amount of time). To participate, the customer may scan or swipe (or enter, read, activate, or otherwise input) their customer identification device at the terminal. Each time the customer participates in this program, the customer may have a chance to win a prize. The prize may be a pre-established prize, random prize, or other prize. The identity of the prize may depend on the customer's tier. The chances of winning may depend on the store (e.g., depending on the amount of customer traffic in a given store), the customer's tier, the season, or any other factor. When a customer wins, the terminal may signal that a customer has won and/or cause the winner to be identified, e.g., by flashing lights on and off at the terminal and/or playing a sound or music.

The customer may receive a reward or reward indicia at the terminal. The terminal may output the reward indicia, which may comprise, e.g., a coupon, voucher (e.g., for a free memory card or other product), receipt, or other indicia of the prize, or it may output the actual prize (e.g., cash or a voucher).

In some embodiments, one or more earned rewards may be obtained and/or redeemed inside the store. For instance, the customer may obtain the reward at a terminal 8 or at a POS 12. The prize may be redeemed inside the store. The size of the prize for this program may be smaller (or larger) than that offered for the programs listed below.

### Example 2

Regional Instant Win. In some embodiments, an Instant Win program (such as that described in Example 1) may be implemented on a regional basis. In other words, one or more winners of a regional “instant win” may be selected from customers associated with a particular region (or other classification). This program may operate similar (or different) to that described for the Instant Win (as described in Example 1). In some embodiments, the rewards earned for a regional instant win program may be more valuable, on average, than those granted in a regular instant win program. In some embodiments, each participant may have an equal chance of winning the regional instant win prize. In some embodiments, there may be other requirements for winning a prize, such as completing a skill test. Requirements may vary by locality, e.g., according to state law.

### Example 3

Frequency program. In some embodiments, one or more rewards may be granted based on the number of times (or frequency at which) one or more customers visit one or more specific stores or types of stores, or otherwise engage in specific reward-earning behaviors related to the store. This program may encourage a customer to visit the store at least once every month (or other time period). The merchant store may track a customer's visits to the store, e.g., by receiving customer identification information at a kiosk or point-of-sale terminal. For each month that the customer visits the store at least once, the customer may earn a single frequency point. Thus, in twelve months, the customer may earn up to twelve frequency points. The maximum number of points may be capped at an upper limit, such as twelve. Frequency points may be accumulated towards prizes. Prizes may have different frequency tiers, and the prizes may also depend on the customer tier. For example, different prizes may be available for three points, six points, nine points, and twelve points, wherein the twelve point prizes are the most valuable. The customer may spend available frequency points on one or more prizes, and any remaining points may be applied toward a future prize. Thus, a customer with seven points could redeem two three-point prizes or one six-point prize and still have one point to be applied toward a later redemption. The customer might alternately save all seven points for a later redemption at the nine or twelve point level.

Some embodiments may account for occasional customer absences, such as vacations. For instance, a reward program may relax some requirements or offer a grace period that may be usable once or twice during the course of a program. For instance, a program that offers an enhanced reward if a customer visits the store at least once per month for a year may enable customers to apply additional visits to a single missed month. In some embodiments the requirement may be relaxed automatically, and in other embodiments the customer may specifically request to apply an additional visit to a prior (or future) month visit, for example. Similarly, programs that accumulate rewards based on visits to (or purchases at) a specific merchant store may enable customers to apply one or more visits to (or purchases at) a different merchant store location (or other affiliated store) toward the program, e.g., on a limited basis.

### Example 4

Regional Prize. In some embodiments, one or more regional prize rewards, such as a single national prize, may be granted to one or more customers. The region encompassed by the regional prize program may comprise a city, state, country, continent, or other geographic region. Classifications other than geography may also be considered, such as customer tier, customer volume of transactions, frequency of visits, classifications based on alphabetical order, random groupings, or any other classification.

In some embodiments, a state or national grand prize may be granted, e.g., at a frequency such as once per year (or at another frequency). In some embodiments having a regional prize reward program, each person (or each customer) who has participated in any program (such as the frequency and instant win rewards programs) may be entered into a lottery for winning a national grand prize.

In some embodiments, the chances of winning the regional prize may depend on a customer's total number of visits, total amount of purchases, outstanding reward balance, length of time in the program (or as a customer in good standing), or any other metric. The prizes here may be much larger than in any other program. For instance, the prize may be a large-screen plasma television.

These four programs in addition to other programs and modifications thereof, as well as additional programs, may be implemented simultaneously.

It should be appreciated that winners of these programs (and others who earn rewards) may be notified of the win and/or reward at any time and via any means of communication. For instance, customer may be notified at any of the following times: immediately; the next login online; the next login via the terminal; the next time the customer visits the store; the next time the customer makes a purchase at a POS terminal; the first day of the next month; on a special “Reward Day”; or any other time. Rewards and/or winnings may be disclosed via email, telephone, mail, terminal communication, POS device, in an account statement, or via other communication means.

Data related to the program may be monitored and tracked. Rewards may be determined based on such data. For instance, customer purchases may be tracked, and rewards may be based on a customer's prior purchases. For instance, if a customer recently purchased a digital camera, a later reward issued to the customer may be a coupon (or voucher) for a memory stick that is designed to fit into the specific camera model. Customer data can also be monitored and tracked, such as the frequency of a customer's visits and the number and amount of the customer's purchases. This data may be processed to evaluate customers, groups of customers, and store performance information.

In some embodiments, the merchant store (or other entities) may provide rewards or other incentives to one or more customers based on customer data. For instance, coupons or targeted ads may be provided to a customer based on the customer's prior purchases or buying habits (e.g., purchases made at the store and/or at other merchants such as partner merchants). For example, an ad for a golf shirt and a coupon for golf balls may be provided to a customer who was identified to purchase a set of golf clubs or a plurality of golf products. Targeted incentives may be provided at the terminal 8 (e.g., when the customer walks into the store), at a POS, via email, or via any other means of communication. For instance, in some embodiments, a customer may automatically receive a targeted reward each time the customer uses the terminal 8.

In some embodiments, one or more rewards programs may be integrated into a terminal. The terminal may be configured to process purchase transactions, loyalty program information, or other customer-related information.

In some embodiments, a customer may earn a $25 coupon (or other prize) as an Instant Win prize, for example. At the time of winning, the terminal may ask the customer whether the customer wants to redeem the prize at the store (e.g., right now). The customer can elect to print out a coupon for later use, have the coupon electronically transferred toward the next purchase in the store, transferred to a point-of-sale device for an immediate purchase, or stored in the customer's reward account.

In some embodiments, one or more rewards may be transferable to others. For instance, a printed reward such as a coupon may be usable by any holder of the coupon. In some embodiments, a one-time-use e-coupon may be emailed to someone else. Some rewards may have restrictions on transfer. For instance, some rewards may be transferred only to other people in the specific reward program or who have accounts with the merchant. In other embodiments, rewards may be transferred only to family or to people listed in a “friends network” on the customer's account.

In some embodiments, multiple programs may be running for a group of customers at the same time. A single customer reward-earning behavior (such as a store visit) may count in more than one of the rewards programs. For instance, a single instance of a customer visit may cause the customer to win both an instant-win (local) prize as well as a national grand prize.

In some embodiments, a coupon may be earned and received from a terminal such as a kiosk, and the coupon may be redeemed (e.g., during a purchase) inside the store (or at the same kiosk or terminal, such as a point-of-sale terminal). In some embodiments, this may be accomplished when a terminal that records customer reward data electronically passes such data to another terminal inside the same store.

This application is related to the technology disclosed in U.S. application No. 683,294 filed Oct. 14, 2003 under Attorney Docket Number 47004.000226, which claims priority to Provisional Application Ser. No. 60/417,658, filed Oct. 11, 2002, both of which are incorporated herein by reference in their entireties.

The embodiments of the present inventions are not to be limited in scope by the specific embodiments described herein. For example, although many of the embodiments disclosed herein have been described with reference to specific rewards programs having defined time periods or frequencies, the principles herein are equally applicable to the any type of rewards program having any timing features. In addition, although many of the embodiments disclosed herein have been described with reference to a single physical terminal located inside a merchant store, it should be appreciated that various aspects of the invention may be accomplished when various system components are located elsewhere. For instance, the terminal may monitor customer data, communicate with a central processor, and output reward information from within the customer's own home. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

1. A method for implementing one or more customer reward programs, comprising:
electronically storing, on a wireless customer identification device, customer identification information associated with a customer reward account;
automatically detecting, by a reward terminal, the physical presence of a customer inside a store of a merchant based on a wireless communication connection established between the wireless customer identification device and the reward terminal, wherein the physical presence is detected without any action by the customer;
automatically receiving, by the reward terminal, the electronically stored customer identification information from the wireless customer identification device via the established wireless communication connection;
automatically generating first reward earning information at the reward terminal based on one or more reward programs, the received customer identification information, and a frequency of the customer's physical presence inside the store, wherein the frequency of the customer's physical presence inside of the store is determined based on the number of times the customer is physically present in the store divided by a corresponding total length of time the customer is physically present in the store;
automatically receiving, by the reward terminal, additional reward earning information transmitted by at least one point-of-sale (POS) device inside the store, wherein the additional reward earning information is generated as a result of reading customer identification information captured by the at least one POS device;
determining that the customer has earned at least a first reward pursuant to the one or more reward programs based on the generated first reward earning information and the received additional reward earning information;
communicating the first reward information to the customer and/or the at least one POS device based on the first reward; and
outputting the first reward information at the reward terminal.

2. (canceled)

3. (canceled)

4. The method of claim 1, wherein communicating the first reward information comprises generating a sound by the reward terminal, wherein the sound indicates that a reward was earned.

5. The method of claim 1, wherein communicating the first reward information comprises generating light by the reward terminal, wherein the light indicates that a reward was earned.

6. The method of claim 1, wherein outputting the first reward information comprises outputting an indicia of the first reward at the reward terminal to distribute the indicia to the customer.

7. (canceled)

8. The method of claim 1, wherein the first reward comprises at least one of a check, coupon, cash certificate, and gift certificate printed from the reward terminal.

9. The method of claim 1, wherein the first reward earning information comprises information about whether the customer accrues a reward pursuant to the one or more reward programs, and wherein the first reward earning information is further based on a determination of the frequency the customer visits the store.

10. The method of claim 1, further comprising:
receiving customer behavior data comprising information about one or more behaviors by the customer inside the store.

11. The method of claim 10, wherein the first reward earning information is further based on the customer behavior data.

12. The method of claim 11, wherein the customer behavior data comprises transaction information about a transaction between the customer and the merchant.

13. The method of claim 12, wherein the transaction information is received by the reward terminal from the at least one POS device inside the store.

14. The method of claim 10, further comprising:
determining second reward earning information by the reward terminal based on the customer behavior data.

15. The method of claim 10, wherein the one or more reward programs are associated with the merchant.

16. The method of claim 1, further comprising:
determining whether the customer earned one or more rewards, in addition to the first reward, pursuant to each of the one or more reward programs.

17. The method of claim 1, wherein the one or more reward programs comprise at least one reward program that provides rewards based on a number of times the customer visits the store in a specific period of time.

18. The method of claim 1, wherein the one or more reward programs comprise at least one reward program that provides rewards based on a number of times the customer visits any store associated with the merchant in a specific period of time.

19. The method of claim 1, wherein the one or more rewards programs comprise at least one reward program that provides the customer a chance to win an instant prize in the store each time the customer visits the store.

20. The method of claim 19, further comprising:
dispensing the instant prize from the reward terminal to the customer upon the customer winning the instant prize.

21. The method of claim 1, wherein the one or more rewards programs comprise at least one reward program that provides a plurality of customers a chance to win an instant prize each time the customer visits one of a plurality of different stores in a region.

22. The method of claim 1, wherein the one or more rewards programs are implemented simultaneously, and wherein the one or more rewards programs comprise:
at least one of the one or more reward programs that provides a chance to win an instant prize in the store each time the customer visits the store; and
at least one of the one or more reward programs that provides the rewards based on the number of times a customer visits the store in a specific period of time.

23. The method of claim 1, wherein the customer earns a level of rewards based on a tier classification of the customer.

24. (canceled)

25. The method of claim 1, wherein detecting the presence of the customer further comprises:
obtaining a biometric measurement of the customer and comparing the biometric measurement to a database of biometric measurements for a plurality of customers.

26. The method of claim 1, wherein detecting the presence of the customer further comprises:
receiving card information associated with the customer.

27. The method of claim 26, wherein the card information associated with the customer is stored on the wireless customer identification device.

28. The method of claim 1, wherein detecting the presence of the customer occurs prior to a purchase by the customer.

29. A terminal for implementing one or more rewards programs, comprising:
an environment monitoring device that automatically detects and receives customer identification information of one or more customers physically inside a store of a merchant based on a wireless communication connection established between a wireless customer identification device and the terminal, independent of any action by the customer, wherein the customer identification information is stored electronically on a wireless customer identification device and further wherein the customer identification information is automatically received from the wireless customer identification device via the established wireless communication connection;
a customer identification module that identifies a customer based on the received customer identification information, the customer being enrolled in at least one reward program;
a frequency module that determines a frequency the customer visits the store of the merchant, wherein the frequency the customer visits the store of the merchant is determined based on the number of times the customer is physically present in the store of the merchant divided by a corresponding length of time the customer is physically present in the store of the merchant;
a point-of-sale (POS) module that communicates with at least one POS device inside the store to automatically receive additional reward earning information transmitted by the at least one POS device, wherein the additional reward earning information is generated as a result of reading customer identification information captured by the at least one POS device;
a reward processor that determines reward earning information based on the received customer identification information, the frequency the customer visits the store, and the at least one reward program and determining that the customer has earned at least a first reward pursuant to at least one reward program based on the reward earning information and the additional reward earning information; and
an output processor and device for communicating the first reward information to the customer and/or the at least one POS device based on the first reward and outputting the first reward information at a reward terminal.

30. (canceled)

31. A method for implementing one or more customer reward programs, comprising:
electronically storing, by a customer reward account key fob, customer identification information associated with a customer reward account;
automatically receiving customer identification information from a customer reward account key fob at a reward terminal inside a merchant store via a wireless communication connection established between the customer reward account key fob and the reward terminal, wherein the reward terminal is physically separate from one or more point-of-sale (POS) devices used to initiate purchase transactions, and wherein the customer is physically inside a store of the merchant;
identifying the customer based on the customer identification information; and
automatically generating reward earning information based on at least one reward program, the received customer identification information, and a frequency of the customer's physical presence inside the store, wherein the frequency of the customer's physical presence inside of the store is determined based on the number of times the customer is physically present in the store divided by a corresponding length of time the customer is physically present in the store;
automatically receiving, by the reward terminal, additional reward terminal earning information transmitted by the one or more POS devices, wherein the additional reward earning information is generated as a result of reading customer identification information captured by the one or more POS devices;
determining that the customer has earned at least a first reward pursuant to at least one reward program based on the generated reward earning information and the received additional reward earning information;
communicating the first reward information to the customer and/or the one or more POS devices based on the first reward; and
outputting at the reward terminal reward information based on the first reward.

32. A method for implementing one or more customer reward programs, comprising:
electronically storing, by a wireless customer identification device, customer identification information associated with a customer reward account;
automatically detecting, by a reward terminal, the physical presence of a customer inside a store of a merchant based on a wireless communication connection established between the wireless customer identification device and the reward terminal, wherein the reward terminal is physically distinct from any point-of-sale (POS) device used for selling goods located inside the store and the detection is performed independent of any action by the customer;
automatically receiving, by the reward terminal, the electronically stored customer identification information from the wireless customer identification device via the established wireless communication connection; and
automatically generating first reward earning information at the reward terminal based on at least one reward program, the received customer identification information, and a frequency of the customer's physical presence inside the store, wherein the frequency of the customer's physical presence inside of the store is determined based on the number of times the customer is physically present in the store divided by a corresponding length of time the customer is physically present in the store;
automatically receiving, by the reward terminal, additional reward earning information transmitted by at least one POS device inside the store, wherein the additional reward earning information is generated as a result of reading customer identification information captured by the at least one POS device;
determining that the customer has earned at least a first reward pursuant to at least one reward program based on the generated first reward earning information and the received additional reward earning information;
communicating the first reward information to the customer and/or the at least one POS device based on the first reward; and
outputting at the reward terminal reward information based on the first reward.

33. The method of claim 1, wherein the reward terminal is located inside the store of the merchant.

34. The terminal of claim 29, wherein the environment monitoring device is located inside the store of the merchant.

35. (canceled)

36. The method of claim 32, wherein the reward terminal is located inside the merchant store.

37. A method for implementing one or more customer reward programs, comprising:
electronically storing, on a wireless customer identification device, customer identification information associated with a customer reward account;
automatically detecting by a reward terminal a presence of a customer inside a location associated with a merchant based on a wireless communication connection established between the wireless customer identification device and the reward terminal independent of any action by the customer;
automatically receiving, by the reward terminal, the electronically stored customer identification information from the wireless customer identification device via the established wireless communication connection;
automatically generating first reward earning information at the reward terminal based on one or more reward programs, the received customer identification information, and a frequency of the customer's presence inside the location associated with the merchant, wherein the frequency of the customer's physical presence inside of the location associated with the merchant is determined based on the number of times the customer is physically present in the location associated with the merchant divided by a corresponding length of time the customer is physically present in the location associated with the merchant;
automatically receiving, by the reward terminal, additional reward earning information transmitted by least one point-of-sale (PUS) device inside the location, wherein the additional reward earning information is generated as a result of reading customer identification information captured by the at least one POS device;
determining that the customer has earned at least a first reward pursuant to the one or more reward programs based on the generated first reward earning information and the received additional reward earning information;
communicating the first reward information to the customer and/or the at least one POS device based on the first reward; and
outputting the first reward information at the reward terminal.

38. The method of claim 1, further comprising:
establishing RFID wireless communications between the wireless customer identification device associated with the customer and the reward terminal; and
communicating, by the reward terminal, customer identification information with the wireless customer identification device via the established RFID wireless communications.

39. The method of claim 38, further comprising:
receiving, at the reward terminal, log in information to a customer account from the wireless customer identification device.

40. (canceled)
